(19) United States
(12) Patent Application Publication
(10) Pub. No.: US 2009/0070804 A1
(43) Pub. Date: Mar. 12, 2009

(54) Autonomous advertising broadcasting system and a method of the same

(75) Inventor: Shiun-Chih Liao, Taichung (TW)

Correspondence Address: BACON & THOMAS, PLLC, 625 SLATERS LANE, FOURTH FLOOR, ALEXANDRIA, VA, 22314-1176, US

(73) Assignee: CHUNGHWA UNITED TELEVISION CO., LTD, Taichung (TW)

(21) Appl. No.: 11/898,097

(22) Filed: Sep. 10, 2007

(51) Int. Cl. H04N 7/10

(52) U.S. Cl. 725/32

(57) ABSTRACT

An autonomous advertising broadcasting system and a method of the same, adapted to broadcast the advertising data publicly at a broadcasting place, wherein the autonomous advertising broadcasting system comprises of a display unit to provide plural image data to display at a same display frame respectively, wherein the said display frame at least includes a first and a second display blocks; an advertising agent data unit at least including an advertising data to provide an advertising agent to broadcast via the display unit; a broadcasting administration unit acquiring the advertising data of the advertising agent data unit and determining the display unit is broadcasted either at the first or second display block; and an autonomous data providing unit providing the administrator of a broadcasting place an autonomy to choose and transmit an autonomous data to the broadcasting administration unit and broadcast at the other one of the first and second display blocks via the broadcasting administration unit.

### FIELD OF THE INVENTION

The present invention relates to an advertising broadcasting system and the method of the same, particularly to an advertising broadcasting system which provides the administrator of a broadcasting place the autonomy to choose broadcasting data to broadcast and the method of the same in addition to broadcast the advertising data provided by the advertising agent publicly.

### BACKGROUND OF THE INVENTION

The conventional structure of the outdoor advertising broadcasting system is that an advertising agent rents a public broadcasting place and installs a broadcasting device to broadcast the advertisement provided by the advertising agent. To achieve the best advantages of the advertisement the advertising agents divides a frame into different display blocks to display different advertisement at each display block. Each display block displays different advertisement respectively to display different advertisements in vision of viewers at the same time. For example the invention of Taiwan patent number 1266526 discloses a switching device which comprises of a television, a set top box and a controller, wherein the television combines the set top box. The set top box converts the input analog image signal of the said television into a digital image signal and outputs images from a television screen and divides them into a reduced image frame and a controlled frame (as advertised—AD banner) to display the said two frames instantly as the television is powered on. The said controller has a control button of frame division switch. When the said control button is pushed, the image frame is displayed in full screen on the television.

However, the advertisements broadcasted in the outdoor advertising broadcasting system are mainly commercial advertising data. Though they can attract viewers at the first time at the installed place, they do not attract viewers who have watched and read the commercial advertisement any more after the same commercial advertising data are broadcasted for a long time. Consequently, the advertisement is much less effected. Alternatively, it may make viewers feel fresh by replacing the commercial advertising data frequently. However, it adds extra works for the advertising agent to replace commercial advertising data frequently. How to manage the broadcasting content effectively to attract viewers in long term has been a great challenge in the industry.

### SUMMARY OF THE INVENTION

The main objective of the present invention is to provide the administrator of an advertising broadcasting place the autonomy to choose data to broadcast with the advertising data of the advertising agent in parallel or respectively. It also provides the administrator the autonomy to choose data to broadcast at a display block alternatively to attract viewers for a long time without replacing advertising data frequently.

To achieve the above mentioned objectives, the present invention provides an autonomous advertising broadcasting system, adapted to broadcast the advertising data publicly at a broadcasting place, comprises of a display unit providing plural image data to be displayed at a same display frame respectively wherein the display frame at least includes a first display block and a second display block; an advertising agent data unit including at least an advertising data to provide advertising agent to broadcast via the display unit; a broadcasting administration unit acquiring the advertising data of the advertising agent data unit and determining that the display unit is broadcasted either at the first display block or the second display block; and an autonomous data providing unit providing the administrator of the broadcasting place an autonomy to choose and transmit an autonomous data to the broadcasting administration unit, and broadcasting at the other one of the first and the second display block via the broadcasting administration unit. As a result, it constitutes a broadcasting system that the advertising agent and administrator of the broadcasting place can broadcast publicly the data they preferred in parallel and respectively.

Furthermore, the present invention provides a method of an autonomous advertising broadcasting system operation, adapted to the above mentioned autonomous advertising broadcasting system, comprises of a detecting step determining whether the autonomous data providing unit and the broadcasting administration unit is electrically connected or not by detecting a connection signal; an image extraction step enabling the broadcasting administration unit to acquire the image data stored in the autonomous data providing unit after determining the electrical connection of the autonomous data providing unit and the broadcasting administration unit in the detection step; a setting reading step reading the broadcasting setting of the display unit, a broadcasting step broadcasting the image data acquired by the broadcasting administration unit at the display unit according to the broadcasting setting of the display unit.

### BRIEF DESCRIPTION OF DRAWINGS

FIG. 1 is a schematic structure representation of an embodiment of the present invention.

FIG. 2 is a schematic display block diagram of another embodiment of the present invention.

FIG. 3 is a schematic flow chart of another embodiment of the present invention.

### DETAILED DESCRIPTION OF THE INVENTION

The other advantage, objective, technical feature and effectiveness of the present invention will be better understood by the detail description of preferred embodiment in conjunction with the following figure.

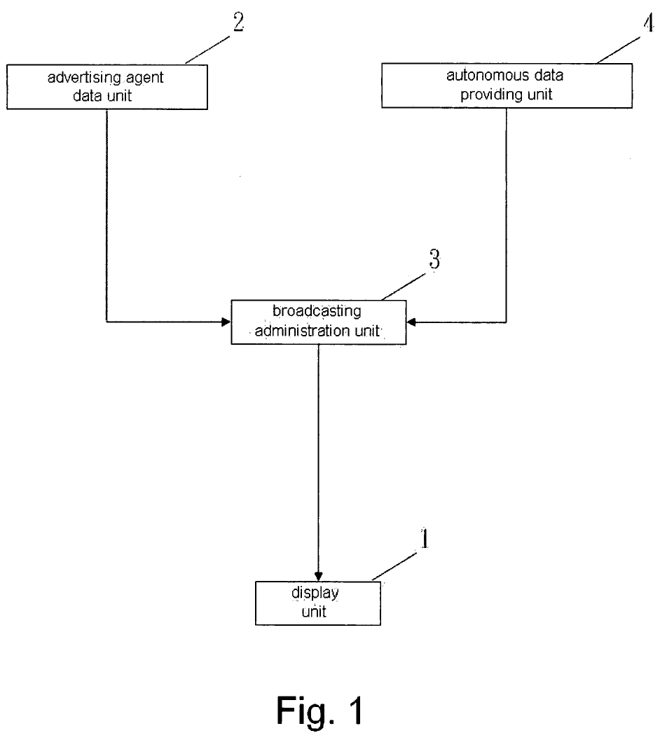

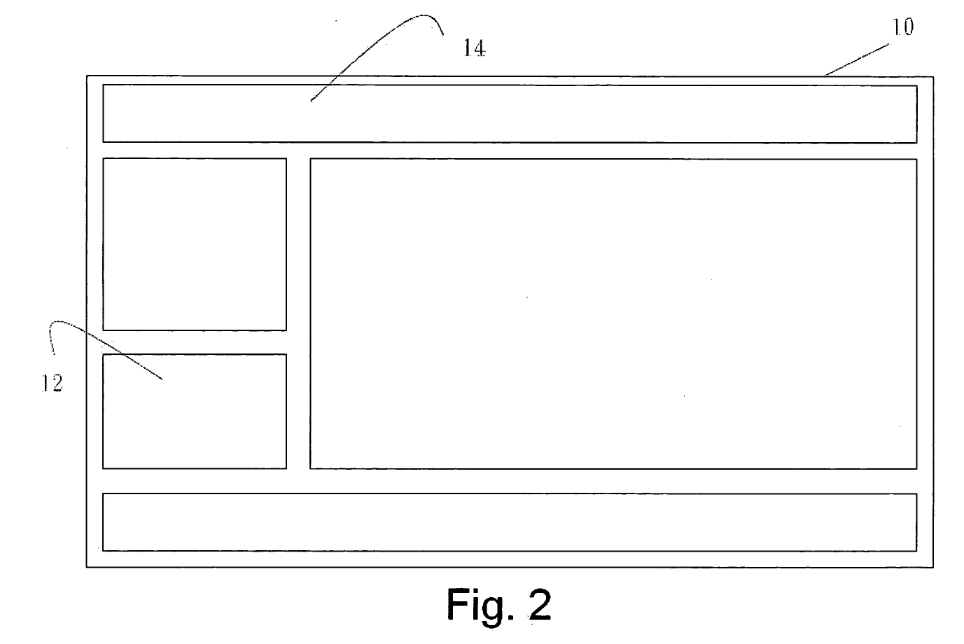

Referring to FIG. 1 and FIG. 2, the present invention provides an autonomous advertising broadcasting system, adapted to broadcast advertising data at a broadcasting place publicly, comprises of: a display unit 1 providing a plurality of image data to be displayed at a same display frame 10 respectively, wherein the display frame 10 at least includes a first display block 12 and a second display block 14, wherein the said display blocks 12, 14 can display respectively by means of picture in picture frame or multi-layer frame; an advertising agent data unit 2 at least including an advertising data to provide the advertising agent to broadcast via the display unit 1; a broadcasting administration unit 3 acquiring the advertising data of the advertising agent data unit 2 and determining that the display unit 1 is broadcasted either at the first display block 12 or the second display block 14; and an autonomous data providing unit 4 providing the administrator of the broadcasting place an autonomy to choose and transmit an autonomous data to the broadcasting administration unit 3 and broadcast at the other one of the first display block 12 and the second display block 14 via the broadcasting administration unit 3. Consequently, it constitutes a broadcasting system that the advertising agent and administrator of the broadcasting place can broadcast the data they preferred publicly in parallel and respectively, wherein the autonomous data can be the audio data contained in the television signal or digital television signal.

It is noted that in the embodiment of the present invention the broadcasting administration unit 3 broadcasts the acquired data (such as the advertising data of the advertising agent or the autonomous data of the administrator of the broadcasting place) directly at the display unit 1. However, in practice in view of the format of the data acquired by the broadcasting administration unit 3 and the setting format of the display unit 1 may not be consistent or compatible, a signal conversion unit (i.e. set top box, not shown in figure) can be added at the broadcasting administration unit 3 to provide format conversion for signals. For example the format of data acquired by the broadcasting administration unit 3 (such as one of AV, RBG, S-VIDEO, DVB-T, DVB-C, DVB-H, DVB-S, ATSC, ISDB-T and DMB-T) is converted into the broadcasting setting format of the display unit 1 (such as the other one of AV, RBG, S-VIDEO, DVB-T, DVB-C, DVB-H, DVB-S, ATSC, ISDB-T and DMB-T).

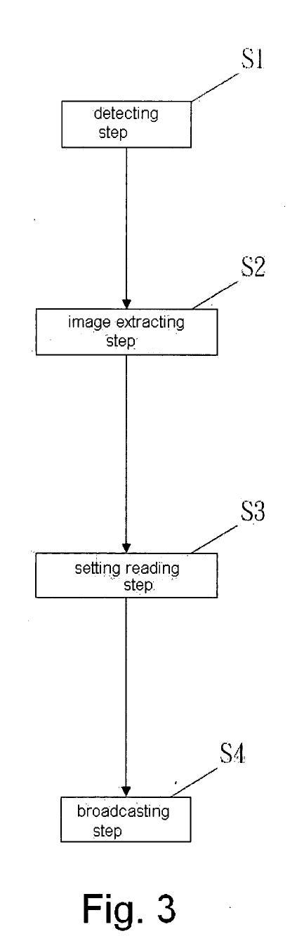

Referring to FIG. 3, furthermore the present invention provides a method of an autonomous advertising broadcasting system operation, adapted to the above mentioned autonomous advertising broadcasting system comprises of: a detecting step S1 determining whether the autonomous data providing unit 4 and the broadcasting administration unit 3 is electrically connected, wherein in the present embodiment if the detecting step S1 determines the autonomous data providing unit 4 and the broadcasting administration unit 3 are electrically connected, it goes on detecting; an image extracting step S2 enabling the broadcasting administration unit 3 to acquire the image data stored in the autonomous data providing unit 4 after the detecting step S1 determines the autonomous data providing unit 4 and the broadcasting administration unit 3 are electrically connected; a setting reading step S3 reading the broadcasting setting of the display unit 1 (i.e. AV, RBG, S-VIDEO, DVB-T, DVB-C, DVB-H, DVB-S, ATSC, ISDB-T and DMB-T); a broadcasting step S4 broadcasting the image data acquired from the broadcasting administration unit 3 at the display unit 1 according to the broadcasting setting of the display unit 1.

To sum up, since the present invention adds an autonomous data providing unit 4 apart from the broadcasting administration unit 3 to have the data of the administrator of the broadcasting place displayed via the method of the autonomous advertising broadcasting system operation of the present invention, it enables the administrator of the broadcasting place to choose data autonomously to broadcast with the advertising data of the advertising agent in parallel and respectively. Furthermore, it attracts viewers for a long term without replacing the advertising data frequently and enables the administrator of the broadcasting place to control the broadcasting frames of the display unit 1 autonomously by means that the administrator chooses data autonomously to change or replace the preferred broadcasting data at one of the display blocks.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An autonomous advertising broadcasting system, adapted to broadcast the advertising data at a broadcasting place publicly, comprising of:
a display unit providing plural image data to display at a same display frame respectively and at least including a first display block and a second display block;
an advertising agent data unit at least including an advertising data to provide an advertising agent to broadcast via the display unit;
a broadcasting administration unit acquiring the advertising data of the advertising agent data unit and determining the display unit to broadcast either at a first display block or a second display block; and
an autonomous data providing unit providing the administrator of a broadcasting place an autonomy to choose and transmit an autonomous data to the broadcasting administration unit and broadcasting at the other one of the first display block and the second display block via the broadcasting administration unit.

2. An autonomous advertising broadcasting system according to claim 1, wherein the first display block and the second display block are displayed in the frame of picture in picture.

3. An autonomous advertising broadcasting system according to claim 1, wherein the first display block and the second display block are displayed in the frame of multi-layers.

4. An autonomous advertising broadcasting system according to claim 1, wherein the broadcasting administration unit is equipped with a signal conversion unit to provide signal conversion.

5. An autonomous advertising broadcasting system according to claim 4, wherein the signal conversion unit provides the following signal formats to convert interchangeably: AV, RBG, S-VIDEO, DVB-T, DVB-C, DVB-H, DVB-S, ATSC, ISDB-T and DMB-T.

6. An autonomous advertising broadcasting system according to claim 1, wherein the autonomous data is the audio and video data contained in the television signal or digital television signal.

7. A method of an autonomous advertisement broadcasting system operation, adapted to an autonomous advertising broadcasting system, wherein the autonomous advertisement broadcasting system acquires the data of an advertising agent data unit and an autonomous data providing unit respectively to broadcast at a same frame of a display unit in parallel and respectively via a broadcasting administration unit, comprising of:
a detecting step determining whether the autonomous data providing unit and the broadcasting administration unit are electrically connected or not by means of detecting a connection signal;
an image extracting step enabling the broadcasting administration unit to acquire the image data stored in the autonomous data providing unit after the detecting step determines the autonomous data providing unit and the broadcasting administration unit are electrically connected;
a setting reading step reading the broadcasting setting of the display unit;
a broadcasting step broadcasting the image data acquired by the broadcasting administration unit at the display unit according to the broadcasting setting of the display unit.

8. An method of an autonomous advertisement broadcasting system operation according to claim 7, wherein if the detecting step determines the autonomous data providing unit is not electrically connected with the broadcasting administration unit it goes on detecting.

9. An method of an autonomous advertisement broadcasting system operation according to claim 7, wherein the broadcasting setting of the display unit is one of the following: AV, RBG, S-VIDEO, DVB-T, DVB-C, DVB-H, DVB-S, ATSC, ISDB-T and DMB-T.
